(19) United States
(12) Patent Application Publication
(10) Pub. No.: US 2022/0036284 A1
(43) Pub. Date: Feb. 3, 2022

(54) REQUEST PROCESSING SYSTEM

(71) Applicant: Honda Motor Co., Ltd., Tokyo (JP)

(72) Inventor: Takahiro Oyama, Tokyo (JP)

(21) Appl. No.: 17/276,144

(22) PCT Filed: Sep. 18, 2019
(86) PCT No.: PCT/JP2019/036483

§ 371 Date: Mar. 13, 2021

(30) Foreign Application Priority Data
Sep. 26, 2018 (JP) 2018-180612

(51) Int. Cl. G06Q 10/06; G06F 3/0481; G06Q 50/30

(52) U.S. Cl. CPC G06Q 10/063114; G06Q 50/30; G06F 3/04817

(57) ABSTRACT

A request processing system includes a management device configured to receive a request from a customer in response to instruction of a manager and to assign the request to a plurality of agents, and a portable terminal carried by each of the agents. The management device is configured to acquire request information from the customer, to assign the request to the plurality of agents, and to transmit the request information to the portable terminal of the plurality of agents to whom the request is assigned. The portable terminal is configured to notify the request information, to input an answer as to whether the request from the customer included in the request information is accepted, and to transmit the answer to the management device. The management device is configured to decide the agent who accepts the request from the customer based on the answer.

### CROSS-REFERENCE TO RELATED APPLICATION

This application is a National Stage of PCT international application Ser. No. PCT/JP2019/036483 filed on Sep. 18, 2019 which designates the United States, incorporated herein by reference, and which is based upon and claims the benefit of priority from Japanese Patent Application No. 2018-180612, filed on Sep. 26, 2018, the entire contents of which are incorporated herein by reference.

### TECHNICAL FIELD

This invention relates to a request processing system for quickly and reliably processing requests from customers.

### BACKGROUND ART

Conventionally, as such a device, there is known a device that corrects a collection and delivery plan so that a vehicle traveling on a collection and delivery route according to a predetermined collection and delivery plan can go to a new collection destination to collect a package in response to a request from a customer (for example, see Patent Literature 1). The device disclosed in Patent Literature 1 determines, with reference to the collection and delivery routes of a plurality of vehicles and the position information sent from on-vehicle devices, one vehicle optimum for incorporating a new collection destination into the collection and delivery route and corrects the collection and delivery plan of the corresponding vehicle.

### CITATION LIST

### Patent Literature

Patent Document 1: Japanese Unexamined Patent Publication No. 2000-259979

### DISCLOSURE OF INVENTION

### PROBLEMS TO BE SOLVED BY THE INVENTION

However, in the device disclosed in Patent Literature 1, it is difficult to process a request from a customer when one vehicle to which a new collection destination is assigned cannot go to the new collection destination due to some reason.

### MEANS FOR SOLVING PROBLEM

An aspect of the present invention is a request processing system, including: a management device configured to receive a request from a customer in response to an instruction of a manager and to assign the request to a plurality of agent; and a portable terminal carried by each of the plurality of agent. The management device includes: a request information acquisition unit configured to acquire second request information of a second request including information of visiting position and visiting time period, the second request information being different from a first request information of a pre-assigned first request; a representative latitude/longitude calculation unit configured to calculate a representative position in each visiting time period for each of the plurality of agent based on the first request information every time the first request information is corrected; an agent assignment unit configured to assign the second request to the plurality of agent based on the representative position calculated by the representative latitude/longitude calculation unit; and an information transmission unit configured to transmit the second request information to the portable terminal of the plurality of agent to whom the second request is assigned by the agent assignment unit. The portable terminal includes: an information notification unit configured to notify the second request information transmitted by the information transmission unit; an answer input unit configured to input an answer as to whether the second request from the customer included in the second request information notified by the information notification unit is accepted; and an answer transmission unit configured to transmit the answer inputted by the answer input unit to the management device. The agent assignment unit decides the agent who accepts the second request based on the answer transmitted by the answer transmission unit. The information notification unit includes: a display unit configured to display the request information transmitted by the information transmission unit. The display unit displays a processing status of the request from the customer including an answer status to the request from the customer on the request information transmitted by the information transmission unit.

### EFFECT OF THE INVENTION

According to the present invention, it becomes possible to quickly and reliably process requests from customers.

### BRIEF DESCRIPTION OF DRAWINGS

FIG. 1 is a diagram illustrating an example of the system configuration of a request processing system according to an embodiment of the present invention.

FIG. 2 is a block diagram illustrating a schematic configuration of a collection agent terminal in FIG. 1.

FIG. 3 is a diagram illustrating an example of an incoming call screen when a spot collection request is received.

FIG. 4 is a diagram illustrating an example of the incoming call screen according to number of notifications until spot collection request is checked.

FIG. 5 is a diagram illustrating an example of request answer screen in FIG. 2, when answering the spot collection request.

FIG. 6A is a diagram illustrating an example of status display displayed on a request content display part in FIG. 5, when accepted the request.

FIG. 6B is a diagram illustrating an example of status display displayed on a request content display part in FIG. 5, when answered that the request cannot be accepted.

FIG. 6C is a diagram illustrating an example of status display displayed on a request content display part in FIG. 5, when accepted by other collection agent before checking the request.

FIG. 6D is a diagram illustrating an example of status display displayed on a request content display part in FIG. 5, when accepted earlier by other collection agent after checking the request.

FIG. 7 is a diagram illustrating an example of display screen of the collection agent terminal in FIG. 2, when displaying a responsible collection list.

FIG. 8 is a block diagram illustrating a schematic configuration of a management server in FIG. 1.

FIG. 9 is a conceptual diagram for transmitting spot collection request information to a plurality of collection agents.

FIG. 10 is a flowchart illustrating an example of processing executed by the management server in FIG. 4.

FIG. 11 is a block diagram illustrating a schematic configuration of a manager terminal in FIG. 1.

FIG. 12 is a diagram illustrating an example of collection agent designation screen of the manager terminal in FIG. 7.

FIG. 13A is a diagram illustrating another example of the collection agent designation screen of the manager terminal in FIG. 7.

FIG. 13B is a diagram illustrating a modification of FIG. 13A.

FIG. 14A is a diagram illustrating an example of a status display displayed on the collection agent designation screen in FIG. 13A, 13B, when not requested.

FIG. 14B is a diagram illustrating an example of the status display displayed on the collection agent designation screen in FIG. 13A, 13B, when the request has not been checked.

FIG. 14C is a diagram illustrating an example of the status display displayed on the collection agent designation screen in FIG. 13A, 13B, when the request has not been answered.

FIG. 14D is a diagram illustrating an example of the status display displayed on the collection agent designation screen in FIG. 13A, 13B, when a predetermined period of time elapses without any one answering to the request.

FIG. 14E is a diagram illustrating an example of the status display displayed on the collection agent designation screen in FIG. 13A, 13B, when everyone answering that the request cannot be accepted.

FIG. 14F is a diagram illustrating an example of the status display displayed on the collection agent designation screen in FIG. 13A, 13B, when the collection agent who accepts the request has been confirmed.

FIG. 15A is a diagram illustrating an example of request status check screen displayed on the manager terminal in FIG. 7.

FIG. 15B is a diagram illustrating another example of the request status check screen displayed on the manager terminal in FIG. 7.

FIG. 16A is a diagram illustrating an example of request answer screen displayed on the collection agent terminal in FIG. 2, after answering the request.

FIG. 16B is a diagram illustrating another example of request answer screen displayed on the collection agent terminal in FIG. 2, after answering the request.

FIG. 17 is a diagram illustrating an example of the screen display of the collection agent terminal in FIG. 2, when the request cannot be accepted.

### DESCRIPTION OF EMBODIMENT

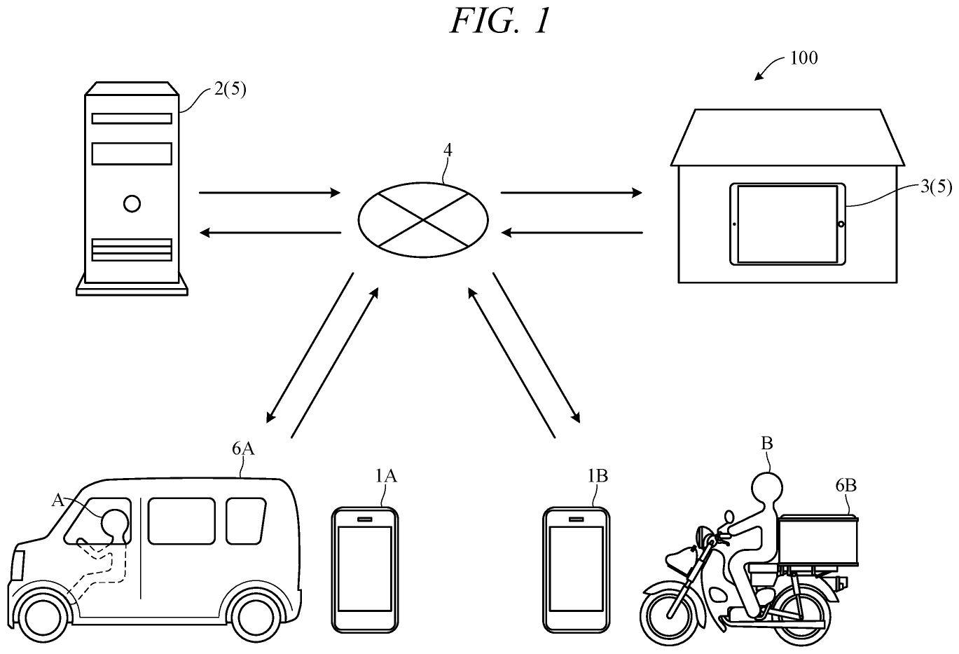

Hereinafter, an embodiment of the present invention will be described below with reference to FIGS. 1 to 17. The request processing system according to the embodiment of the present invention can be used in various types of request processing systems for processing requests from customers. In the following, particularly, an example applied to a request processing system for a collection service, in which, at a collection and delivery center of a delivery company or a collection and delivery base of post offices or the like, a manager of the base receives a collection request and assigns the collection request to a collection agent visiting collection destinations to make the collection, is described. That is, the described is an example in which the collection request is assigned to the collection agent in charge of collection at the collection and delivery center of the delivery company or the collection and delivery base of the post offices.

The collections performed by a collection agent in such a collection service include daily collection performed at a predetermined collection destination (daily collection destination) at a predetermined time or time period and spot collection performed at a collection destination (spot collection destination) at a time period designated (designated time period) according to a collection request received in a spot manner (spot collection request). The base manager who receives the spot collection request at a delivery base necessarily decides quickly and reliably the collection agent who visits the spot collection destination in the designated time period among the collection agents who visit the daily collection destinations. In the present embodiment, a request processing system is configured as follows to quickly and reliably process a request from a customer.

[Functional Configuration of Request Processing System 100]

First, a functional configuration of a request processing system 100 according to an embodiment of the present invention will be described. FIG. 1 is a diagram illustrating an example of the system configuration of the request processing system 100. As illustrated in FIG. 1, the request processing system 100 includes a plurality of (two in the drawing) collection agent terminals 1A and 1B, a management server 2, and a manager terminal 3 which are connected by a network 4 including a public wireless communication network represented by an Internet network, a mobile phone network, or the like. In such a request processing system 100, the management server 2 and the manager terminal 3 together configure a management device 5 according to an embodiment of the present invention. Incidentally, the management server 2 or the manager terminal 3 may independently configure the management device 5. Incidentally, the network 4 includes a closed communication network provided for each predetermined management area, for example, a wireless LAN and Wi-Fi (Wireless Fidelity) (registered trademark).

The collection agent terminals 1A and 1B can be stored in a pocket of clothes, a carry-on bag, a pouch, or the like or be installed in cradles or the like of vehicles 6A and 6B used at the time of collection to be used by collection agents A and B visiting the collection destinations. In this embodiment, smart phones, tablet terminals, cellular phones, PDAs (Personal Digital Assistant), and further various wearable terminals which can be connected to public wireless communication are collectively referred to as the collection agent terminals 1A and 1B. The collection agent terminals 1A and 1B have a common configuration. Incidentally, the number of the collection agent terminals 1A and 1B may be three or more. The vehicles 6A and 6B are transport vehicles such as a four-wheeled vehicle, a motorcycle, a bicycle, a handcart, and the like. As examples, FIG. 1 illustrates a light truck (for example, a truck having a predetermined exhaust volume or less) 6A and a motorized bicycle (for example, a motorcycle equipped with a prime mover having a predetermined exhaust volume or less) 6B which are widely used for the collection and delivery of packages and mail.

Next, the configurations of the collection agent terminals 1A and 1B, the management server 2, and the manager terminal 3 will be described.

<Collection Agent Terminals 1A and 1B>

First, the collection agent terminals 1A and 1B will be described. Various application software can be installed in the collection agent terminals 1A and 1B, and the collection agent terminals 1A and 1B according to this embodiment configure a request processing system by the application software installed in a smart phone. By using a commercially available smartphone, the cost of building the system can be reduced.

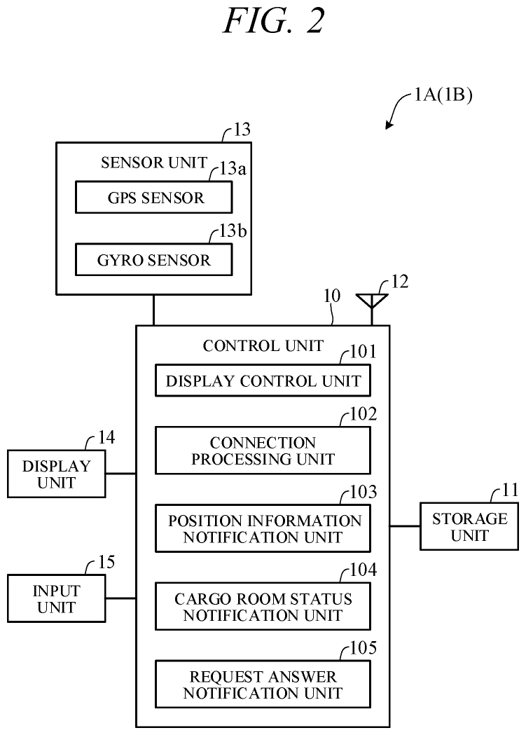

FIG. 2 is a block diagram illustrating a schematic configuration of the collection agent terminal 1A or 1B. As illustrated in FIG. 2, the collection agent terminal 1A includes a control unit 10, a storage unit 11, a wireless unit 12, a sensor unit 13, a display unit 14, and an input unit 15.

The storage unit 11 includes a semiconductor memory, a hard disk, and the like. The storage unit 11 stores various kinds of information such as an operating system (OS), software including an application program for supporting a collection operation, map information such as a road map and a house map, and customer information of a collection destination. The customer information includes information related to the customer such as the presence or absence of a home delivery box in addition to the address and telephone number of the collection destination. Incidentally, the software, the map information, and the customer information may be stored in advance in the storage unit 11 or may be acquired from the management server 2. Further, the storage unit 11 stores information including addresses (residence indication, latitude, longitude), telephone numbers, designated times, and the like of daily collection destinations assigned in advance to the collection agents A and B corresponding to the collection agent terminals 1A and 1B.

The wireless unit 12 has a DSP (Digital Signal Processor) or the like, and is configured to be capable of wireless communication with the management server 2 via a wireless communication network represented by a mobile phone network such as 3G, LTE, 4G, and 5G. The wireless unit 12 may be configured to include a proximity radio communication unit (not illustrated) to which a proximity radio communication technology such as Wi-Fi (registered trademark) and Bluetooth (registered trademark) can be applied. The wireless unit 12 can transmit a login ID (also called “collection agent ID”) for identifying the collection agents A and B, the current position information of the collection agents A and B or the vehicles 6A and 6B, a cargo room status, an answer to a spot collection request, and the like to the management server 2, and receive spot collection request information, the processing status of the spot collection request, and the like from the management server 2.

The sensor unit 13 includes a GPS sensor 13a for receiving positioning signals from a plurality of GPS satellites to measure absolute positions (latitude, longitude) of the collection agents A and B corresponding to the collection agent terminals 1A and 1B, and a gyro sensor 13b for detecting an angular velocity. The current position can also be calculated based on the basis of base station information of the wireless communication network acquired from the wireless unit 12. The traveling speeds (vehicle speed) of the vehicles 6A and 6B can be calculated from the time series changes of the position information acquired by the GPS sensor 13a. In a case where the reception of the positioning signal from the GPS satellite is impossible, the current positions of the collection agents A and B or the vehicles 6A and 6B can be calculated on the basis of the base station information acquired from the wireless unit 12 by using AGPS (Assisted Global Positioning System) communication.

The display unit 14 includes a display device such as a liquid crystal display or an organic EL panel. In response to an instruction from the control unit 10, the display unit 14 displays a map, an icon of an operation button for a touch panel, and the like and displays various kinds of information such as the current positions of the collection agents A and B or the vehicles 6A and 6B and the map in the vicinity of the current position and the collection destination. Further, the processing status of the unanswered spot collection request received from the management server 2 and the answered spot collection request is displayed. Further, the daily collection destinations stored in the storage unit 11 and newly accepted spot collection request information can be displayed in a list in time series.

The input unit 15 includes a physical switch such as a numeric keypad operated by the collection agents A and B and an input device (not illustrated) such as a touch panel superimposed on the display surface of the display unit 14. A signal based on an operation input from the input unit 15, for example, the pressing of the numeric keypad by the collection agents A and B and the pressing of the touch panel is output to the control unit 10, whereby the collection agents A and B can perform operations such as answering whether or not to accept the spot collection request.

Incidentally, although not illustrated, the collection agent terminals 1A and 1B may be additionally provided with speakers, vibrators, lights, microphones, and the like.

The speaker, the vibrator, and the light notify various kinds of information to a collection agent by sound, vibration, and light. Further, the speaker outputs a voice to the collection agent, and the microphone collects the voice or the like emitted by the collection agent. Accordingly, various kinds of information can be outputted through the voice from the speaker, and various commands of the collection agent voice-inputted through the microphone can be inputted to the control unit 10 by using a voice recognition technology.

The control unit 10 includes a microprocessor having a CPU, a RAM, a ROM, an I/O, and the like. The CPU executes a program stored in advance, and exchanges signals with the storage unit 11, the wireless unit 12, the sensor unit 13, the display unit 14, and the input unit 15. The control unit 10 has, as a functional configuration, a display control unit 101, a connection processing unit 102, a position information notification unit 103, a cargo room status notification unit 104, and a request answer notification unit 105.

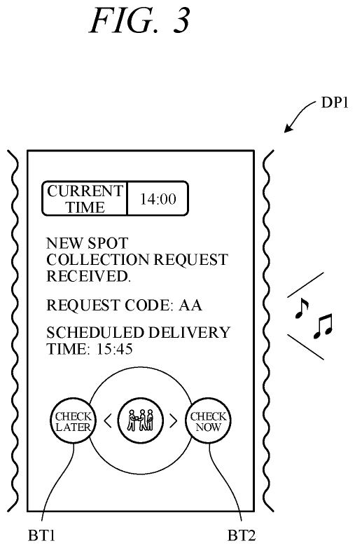

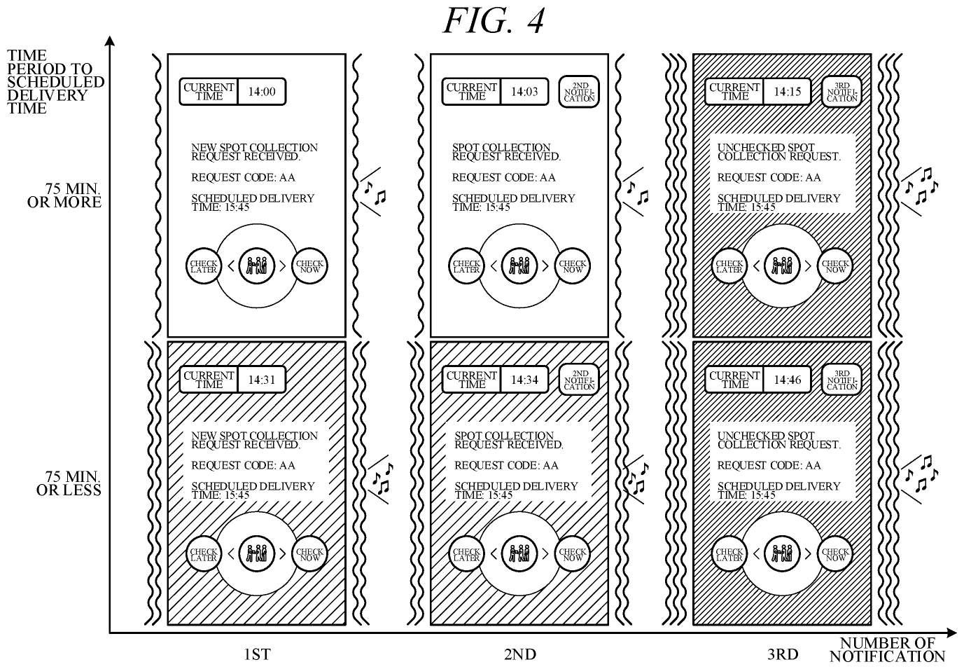

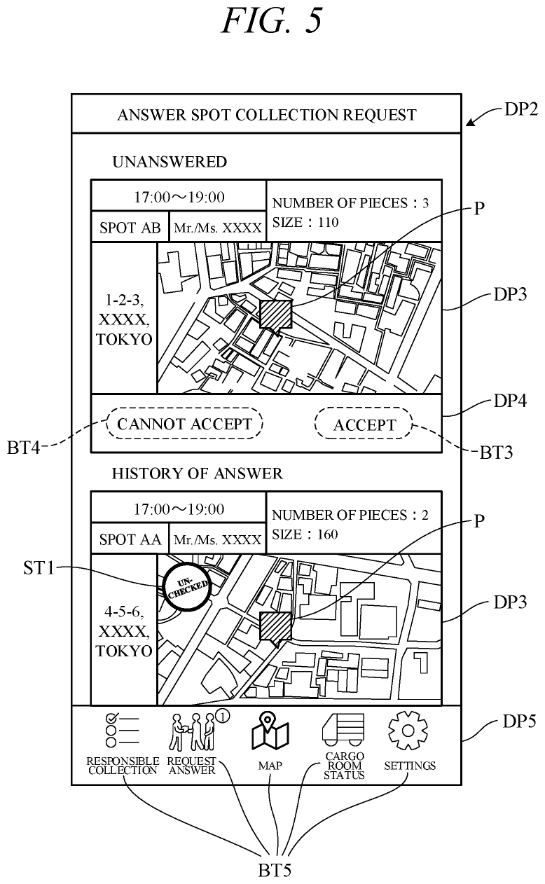

The display control unit 101 generates an image signal in response to the operation of the input unit 15 or in response to the reception of the spot collection request information or the like by the wireless unit 12 and transmits the image signal to the display unit 14, thereby controlling the screen display by the display unit 14. The screen display displayed on the display unit 14 by the display control unit 101 includes a login screen for logging in to the request processing system 100, a cargo room status screen for inputting the loading status of the cargo room of the vehicles 6A and 6B and transmitting the loading status to the management server 2, an incoming call screen (FIGS. 3 and 4) for displaying spot collection request information received from the management server 2, and a request answer screen (FIG. 5) for answering the received spot collection request, and the like. When receiving the spot collection request information from the management server 2 via the wireless unit 12, the display control unit 101 generates an image signal for displaying the incoming call screen and transmits the image signal to the display unit 14. When the spot collection request information is received, a notification command may be further transmitted to the speaker, the vibrator, or the light, and various kinds of information may be notified to the collection agent by sound, vibration, or light.

On the login screen displayed on the display unit 14, the connection processing unit 102 transmits the login ID and password inputted by the collection agents A and B via the input unit 15 to the management server 2 via the wireless unit 12. Accordingly, the collection agent terminals 1A and 1B are connected to the management server 2 in a communicable state. The login input by the collection agent is executed at the time of the operation start of the collection agent, that is, when the collection agent departs from the delivery base. Further, when logout is inputted through the input unit 15, the connection processing unit 102 transmits logout to the management server 2 through the wireless unit 12. Accordingly, the communication connection between the collection agent terminals 1A and 1B and the management server 2 is terminated. The logout input by the collection agent is executed at the time of the operation end of the collection agent, that is, when the collection agent returns to the delivery base. Incidentally, the logout may be automatically executed on the basis of the time and position information when the collection agent returns to the collection and delivery base.

The position information notification unit 103 transmits the current position information, which is calculated by signals from the sensor unit 13 (GPS Sensor 13a), of the collection agents A and B or the vehicles 6A and 6B moving together with the collection agent terminal 1A or 1B and the current time information acquired from a clock unit (not illustrated) via the wireless unit 12 to the management server 2 at predetermined time intervals (for example, every three seconds) in association with the collection agent ID. Incidentally, the time information includes not only the time but also information such as the date. The management server 2 can also calculate the moving speed and the traveling direction of the collection agent or the vehicle from the time series change of the position information of the vehicle.

The positions of the vehicles 6A and 6B change from time to time. Thus, when the current position information is acquired at predetermined time intervals, the position obtained from the latest current position information may not exactly coincide with the actual position. However, the deviation is small. Thus, the position obtained from the current position information acquired at predetermined time intervals can be regarded as the current position. Incidentally, a plurality of pieces of the current position information, the current time information, and the like of the collection agents A and B or the vehicles 6A and 6B acquired at predetermined time intervals can be collectively transmitted (so-called burst transmission) at once. The acquisition time interval (for example, every three seconds) of the current position information of the collection agent or the vehicle, the number of pieces to be transmitted at one time when a plurality of pieces are burst-transmitted collectively, and the like can be set in advance.

When the cargo room status is inputted on the cargo room status screen displayed on the display unit 14 through the input unit 15, the cargo room status notification unit 104 transmits the cargo room status to the management server 2 through the wireless unit 12 in association with the collection agent ID. The cargo room status is displayed to be selectable from a plurality of statuses indicating the status of the cargo room such as a situation in which the cargo room is full and no more collection is acceptable (100%), a situation in which a few more collection is acceptable (90%), a situation in which the cargo room is still a margin (60%), and a situation in which the cargo room is almost empty (30%).

FIG. 3 is a diagram illustrating an example of an incoming call screen DP1 when a spot collection request is received. As illustrated in FIG. 3, when a spot collection request is received from the management server 2 via the wireless unit 12, the incoming call screen DP1 is displayed on the display unit 14 of the collection agent terminal 1A or 1B. Further, through the speaker, vibrator, and light of the collection agent terminal 1A or 1B, the arrival of the spot collection request is notified by sound, vibration, and light. On the incoming call screen DP1 of the spot collection request, the identification code (in the example of the drawing, a string of two alphabetic characters) of the spot collection request is displayed as a request code, and the scheduled delivery time (designated time) of the spot collection request is displayed. Further, check buttons BT1 and BT2 for “I'll check it later” or “I'll check it now” are displayed to select the contents of the spot collection request.

FIG. 4 is a diagram illustrating an example of the incoming call screen DP1 according to the number of notifications until the spot collection request is checked. In a case where any one of the collection agents A and B receiving the spot collection request does not press the check button BT2 of “I'll check it now” on the incoming call screen DP1 of FIG. 3 and no one checks the notification, the incoming call screen DP1 is displayed again after a predetermined time. For example, the second notification is issued three minutes after the first notification. In a case where the second notification is not checked, for example, the third notification is made five minutes after the first notification. As illustrated in FIG. 4, when the number of notifications until the spot collection request is checked increases or when the time until the designated time of the spot collection request decreases, the background color of the incoming call screen DP1 is highlighted by a stronger shade or the like. Further, the volume of a ringtone is increased, and the magnitude of vibration is increased.

FIG. 5 is a diagram illustrating an example of the request answer screen when answering the spot collection request. When the check button BT2 of “I'll check it now” is pressed on the incoming call screen DP1 of FIG. 3, the request answer screen DP2 illustrated in FIG. 5 is displayed, and the spot collection request information is displayed as an unanswered request. Specifically, a request content display part DP3 displays a peripheral map of the spot collection destination P, and the name, address, collection contents, and designated time period of the spot collection destination P, and a request answer input part DP4 under the request content display part DP3 displays request answer buttons BT3 and BT4 of “accept” or “unacceptable” in a selectable manner. When the request answer input part DP4 displayed on the display unit 14 presses the request answer button BT3 or BT4 via the input unit 15 (touch panel), a request answer notification unit 105 transmits an answer to the spot collection request in association with the collection agent ID via the wireless unit 12 to the management server 2.

As illustrated in FIG. 5, the request answer screen DP2 displays a history of answered requests or the like in addition to unanswered requests. Further, the request content display part DP3 of the history display displays a processing status ST1 indicating the answer status of each spot collection request.

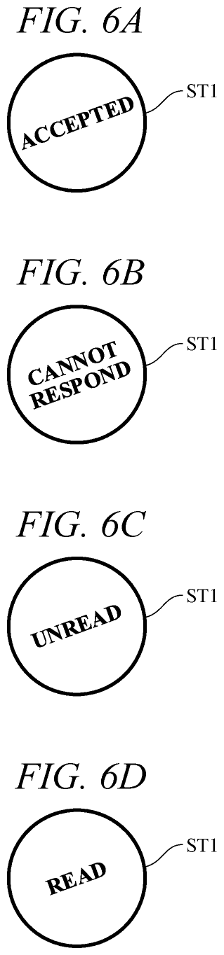

FIGS. 6A to 6D are diagrams illustrating an example of the status display on the request answer screen DP2 of FIG. 5. The processing status ST1 (accepted) in FIG. 6A is a status display displayed on the request content display part DP3 of the spot collection request which is confirmed to be accepted from the history display of the request answer screen DP2. The processing status ST1 (cannot respond) in FIG. 6B is a status display displayed on the request content display part DP3 of the spot collection request which is answered that the request cannot be accepted. The processing status ST1 (unread) in FIG. 6C is a status display displayed on the request content display part DP3 of the spot collection request which is accepted by other collection agent before checking the request contents of the spot collection request. The processing status ST1 (read) in FIG. 6D is a status display displayed on the request content display part DP3 of the spot collection request which is accepted earlier by other collection agent after checking the request contents of the spot collection request. With respect to the requested spot collection request, the collection agents A and B who receive the spot collection request can easily grasp the processing status of whether it is confirmed that the request is accepted by oneself or the request is accepted by other collection agent by checking the processing status ST1 of the history display.

As illustrated in FIG. 5, a menu screen DP5 is displayed at a lower portion of the display unit 14. On the menu screen DP5, menu buttons BT5 of “responsible collection”, “request answer”, “map”, “cargo room status”, “settings”, and the like are displayed to be selectable. By pressing each menu button BT5, switch can be made to a screen display corresponding to each menu button BT5.

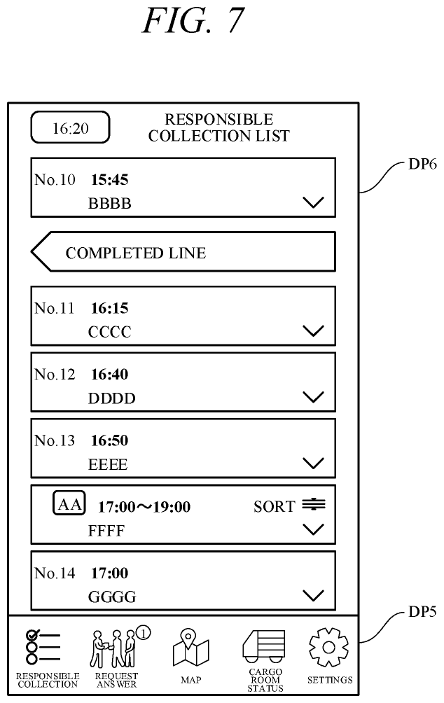

FIG. 7 is a diagram illustrating an example of a responsible collection list screen DP6 displayed when the menu button BT5 of “responsible collection” is pressed on the menu screen DP5. As illustrated in FIG. 7, on the responsible collection list screen DP6, the information of the daily collection destinations for which each collection agent is responsible and the accepted spot collection destinations are displayed in a list in time series. Incidentally, the daily collection destinations are assigned serial numbers using numerals such as “No. 10” and “No. 11”, and the spot collection destinations are assigned identification codes (request code) using alphabets such as “AA”. Since the serial number using numerals is assigned to the daily collection, and the identification code using alphabets is assigned to the spot collection, the collection agent can easily identify the spot collection which is accepted by oneself on the screen, and can easily prevent the correspondence omission of the collection operation.

<Management Server 2>

Next, the management server 2 will be described. The management server 2 is described as one server having various functions in this embodiment. However, the management server 2 may be a distribution server configured by different servers for functions or may be realized by a cloud server (virtual server).

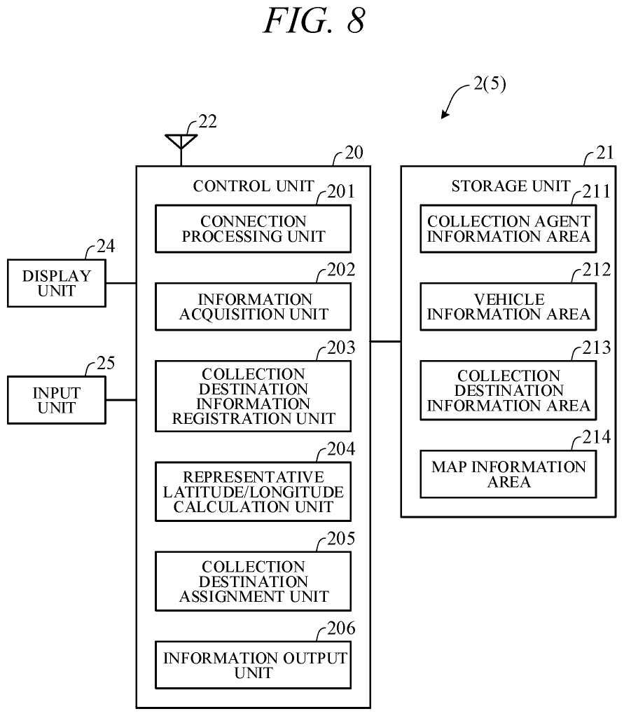

FIG. 8 is a block diagram illustrating a schematic configuration of the management server 2. As illustrated in FIG. 8, the management server 2 includes a control unit 20, a storage unit 21, a communication unit 22, a display unit 24, and an input unit 25. Incidentally, the display unit 24 and the input unit 25 may be omitted. Further, the display unit 24 and the input unit 25 may be configured by another information terminal (not illustrated) connected to the management server 2.

The storage unit 21 includes a semiconductor memory, a hard disk drive, and the like. The storage unit 21 stores an operating system (OS), software called an application, and various kinds of other information. For this reason, the storage unit 21 secures various storage areas such as a collection agent information area 211, a vehicle information area 212, a collection destination information area 213, and a map information area 214. Incidentally, the information area is, for example, a table in a database management system.

The collection agent information area 211 stores, for each employee ID (also called “collection agent ID”) which is the identification information of a collection agent, collection agent information for managing basic information on the corresponding collection agent, for example, the name of the collection agent, an affiliation base ID, and workable time. Further, in the collection agent information area 211, a vehicle ID which is the identification information of the vehicles 6A and 6B is stored in association with the collection agent ID. The correspondence of the vehicle ID to the collection agent ID is set in advance, for example, by the manager of the delivery base prior to the start of the daily collection management operation.

In the vehicle information area 212, for each vehicle ID, the information relating to the corresponding vehicle, for example, the vehicle type such as a four-wheeled vehicle, a motorcycle, and a bicycle, the size of a cargo room, and the like are stored in advance, and the cargo room statuses received from the collection agent terminals 1A and 1B are stored.

In the collection destination information area 213, the daily collection destination information including the address (residence indication, latitude, longitude) of a daily collection destination, a telephone number, a designated time, and the collection agent A or B assigned to the collection destination is stored in advance, and the spot collection request information including the address (residence indication, latitude, longitude) of the spot collection destination newly received from the manager terminal 3, a telephone number, collection contents, a designated time period, and the like is stored. Further, when the collection agent A or B who accepts the spot collection request is decided, the information of the collection agent ID of the collection agent A or B and the vehicle ID of the vehicle 6A or 6B is also stored.

Map information is stored in advance in the map information area 214. The map information includes road link information, display map data for displaying the background of a road, a road map, and the like, road type information (general roads or expressways), and the like. These map information are periodically updated.

When transmitting/receiving with the collection agent terminal 1A or 1B, the communication unit 22 implements a communication protocol, such as 3G, LTE, 4G, and 5G, capable of performing wireless communication. On the other hand, when transmitting/receiving with the manager terminal 3, the communication unit 22 implements a communication protocol capable of performing wired communication (for example, Internet lines) or wireless communication.

The control unit 20 includes a processor having a CPU, a RAM, a ROM, an I/O, and the like. The control unit 20 has, as a functional configuration, a connection processing unit 201, an information acquisition unit 202, a collection destination information registration unit 203, a representative latitude/longitude calculation unit 204, a collection destination assignment unit 205, and an information output unit 206.

The connection processing unit 201 executes login processing from the collection agent terminals 1A and 1B and performs connection processing with the collection agent terminals 1A and 1B. Further, the connection processing unit 201 executes logout processing from the collection agent terminals 1A and 1B and terminates the connection with the collection agent terminals 1A and 1B. Further, the connection processing unit 201 executes login processing from the manager terminal 3 to perform connection processing with the manager terminal 3, and executes logout processing from the manager terminal 3 to terminate the connection with the manager terminal 3.

The information acquisition unit 202 acquires various kinds of information by receiving the data transmitted from the collection agent terminals 1A and 1B to the management server 2 and the data transmitted from the manager terminal 3 to the management server 2 through the communication unit 22. The information acquired by the information acquisition unit 202 includes the position information of the collection agents A and B or the vehicles 6A and 6B transmitted from the position information notification units 103 of the collection agent terminals 1A and 1B, the time information corresponding to the position information, the cargo room status of the vehicles 6A and 6B transmitted from the cargo room status notification unit 104, the answer to the spot collection request transmitted from the request answer notification unit 105, the spot collection request information transmitted from the manager terminal 3, and the like.

The collection destination information registration unit 203 registers a collection destination data record in the collection destination information area 213 and corrects the record. That is, in a case where the information of registration and correction of the daily collection destination information is received from the manager terminal 3, the daily collection destination information stored in the collection destination information area 213 is registered and corrected on the basis of the received information. Further, in a case where the collection agent A or B accepting the spot collection request is decided, the information (collection agent ID) of the corresponding collection agent A or B is added to the collection destination information area 213.

The daily collection destination information stored in advance in the collection destination information area 213 is managed for each of the collection agents A and B (collection agent ID) and for each collection time period. The collection time period is a predetermined time period for each delivery base, and a spot collection request to the delivery base is received for each same time period. Specifically, the position information is expressed in latitude and longitude.

The representative latitude/longitude calculation unit 204 calculates a representative position in each collection time period for each collection agent on the basis of the daily collection destination information stored in advance in the collection destination information area 213. The representative position is a representative position which each collection agent visits in each time period, and can be calculated, for example, as the average value (arithmetic mean) of the latitudes and longitudes of the daily collection destinations to be visited in each time period. In a case where weighting is applied in accordance with the estimated length of stay for each daily collection destination and the traffic situation in the peripheral area, the representative position can be calculated as a weighted average. The representative position information obtained by the calculation by the representative latitude/longitude calculation unit 204 is stored in the collection destination information area 213.

The representative latitude/longitude calculation unit 204 calculates the average value of the representative positions of all the collection time periods as the representative position in a case where no collection time period is designated. Every time the daily collection destination information is registered and corrected, the representative latitude/longitude calculation unit 204 calculates the representative position of the corrected collection time period and the representative position in a case of no designated collection time period (all collection time periods). Accordingly, the latest representative position is always stored in the collection destination information area 213, and thus, the response of the processing by the collection destination assignment unit 205 described later can be improved.

The collection destination assignment unit 205 assigns the spot collection requests to the collection agents A and B on the basis of the information stored in the collection destination information area 213. Specifically, the collection destination assignment unit 205 first selects a plurality of collection agents (candidate collection agents) in the order in which the representative position calculated by the collection destination information registration unit 203 is closer to the address (residence indication, latitude, longitude) of the spot collection destination in the designated time period of the spot collection request. For example, the collection agents A to C are selected as candidate collection agents A to C. The information of the selected candidate collection agents A to C is transmitted to the manager terminal 3.

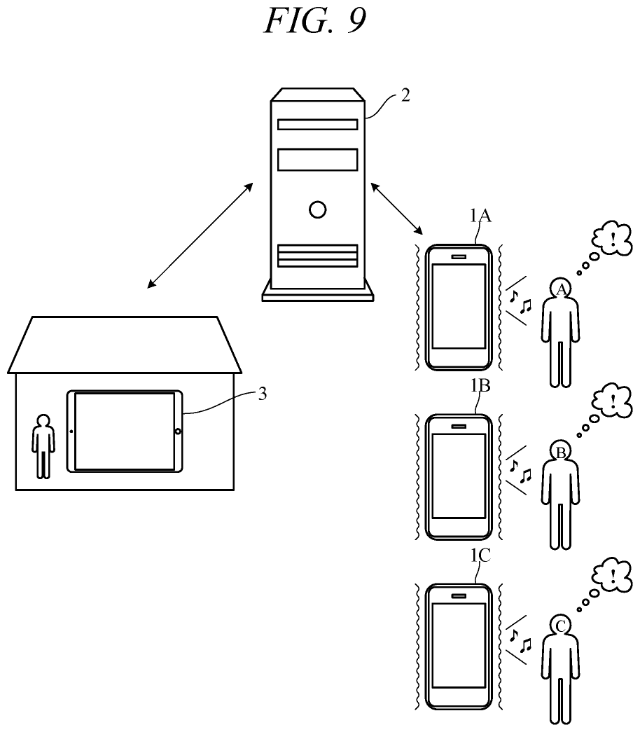

FIG. 9 is a conceptual diagram for transmitting spot collection request information to a plurality of collection agents. The manager refers to the information of the candidate collection agents A to C transmitted from the management server 2, and designates a plurality of the candidate collection agents (transmission destination collection agents—three collection agents A to C are shown in the drawing) to whom the spot collection request information is transmitted through the manager terminal 3. Alternatively, the manager terminal 3 automatically designates a transmission destination collection agent according to a predetermined condition without the command of the manager. For example, all the candidate collection agents A to C transmitted from the management server 2 are designated as the transmission destination collection agents. The collection destination assignment unit 205 decides the transmission destination collection agent to whom the spot collection request information is transmitted according to the designation result of the collection agents by the manager or the manager terminal 3. Accordingly, even in a case where the manager who assigns the collection operation at the delivery base has little experience or a case where there is no manager at the delivery base, it is possible to efficiently decide the transmission destination collection agent to whom the spot collection request information is transmitted.

Incidentally, when selecting the candidate collection agents A and B, on the basis of the type and the cargo room status of the vehicles 6A and 6B stored in the vehicle information area 212, the collection contents included in the spot collection request information stored in the collection destination information area 213, and the like, the collection destination assignment unit 205 can exclude the collection agent who cannot accept the spot collection request, for example, since the cargo room status is 100%. Further, the collection agents whose the position information is not communicated for a certain period of time (for example, three minutes) or more may be excluded. The number or the like of the candidate collection agents selected by the collection destination assignment unit 205 may be set in advance. Incidentally, the candidate collection agent may be decided on the management server 2 side without transmitting the information of the candidate collection agent to the manager terminal 3.

After the spot collection request is assigned to the collection agents A to C by the collection destination assignment unit 205, for the collection agents A to C to whom the spot collection request is assigned, the representative latitude/longitude calculation unit 204 may calculate (update) the representative position in the designated time period and the representative position in a case of no designated collection time period. In this case, the representative position in the designated time period of the spot collection request may be calculated as the average value of the latitudes and longitudes of all the daily collection destinations in the designated time period and newly assigned spot collection destinations. Accordingly, the representative position of the collection agent A managed by the management server 2 becomes a more accurate position.

The collection destination assignment unit 205 decides the collection agent (assigned collection agent) who accepts the spot collection request in consideration of the answer transmitted from the collection agent terminals 1A to 1C of the collection agents A to C about whether or not to accept the spot collection request. More specifically, the collection agent receiving the answer to accept the spot collection request first via the communication unit 22 is decided as the assigned collection agent accepting the spot collection request.

The information output unit 206 outputs various kinds of information by transmitting data from the management server 2 via the communication unit 22 to the collection agent terminals 1A and 1B and the manager terminal 3. The information output by the information output unit 206 includes the selection results of the plurality of candidate collection agents A to C transmitted to the manager terminal 3, the spot collection request information transmitted to the collection agent terminals 1A to 1C, the information of the assigned collection agent who accepts the spot collection request decided by the collection destination assignment unit 205, and the like.

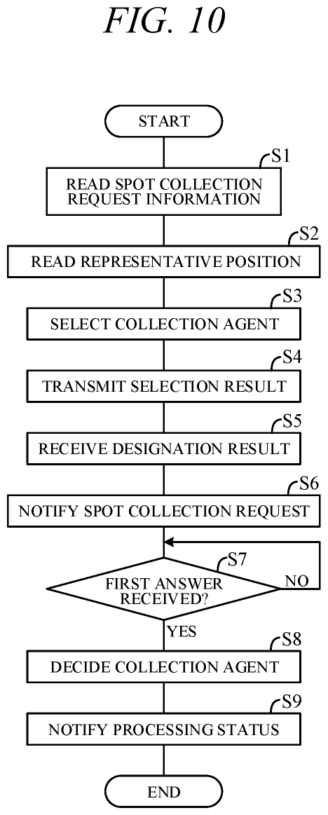

FIG. 10 is a flowchart illustrating an example of processing executed by the CPU of the management server 2 according to a program stored in advance. The processing illustrated in this flowchart is started when the spot collection request information is received from the manager terminal 3, for example.

First, in step S1, the spot collection request information received from the manager terminal 3 via the communication unit 22 is read by the processing of the information acquisition unit 202. Next, in step S2, the representative position in the designated time period of the spot collection request calculated by the collection destination assignment unit 205 and stored in the collection destination information area 213 is read by the processing of the collection destination assignment unit 205. Next, in step S3, a plurality of collection agents, for example, three collection agents A to C (candidate collection agent) are selected in the order in which the representative position is closer to the address of the spot collection destination. Next, in step S4, the selection result of the collection agents A to C are transmitted the manager terminal 3 by the processing of the information output unit 206. Accordingly, the transmission destination collection agent is designated in the manager terminal 3.

Next, in step S5, the designation result of three collection agents, for example, the three collection agents A to C (transmission destination collection agent) received from the manager terminal 3 via the communication unit 22 are received by the processing of the information acquisition unit 202. Next, in step S6, by the process of the information output unit 206, the spot collection request information is transmitted to the collection agent terminals 1A to 1C of the designated transmission destination collection agents A to C according to the designation result of the collection agents A to C received in step S5. Next, in step S7, by the processing of the collection destination assignment unit 205, it is determined whether or not the first acceptance answer to the spot collection request is received from any of the collection agent terminals 1A to 1C through the communication unit 22. Step S7 is repeated until it is determined to be affirmative. When it is determined to be affirmative in step S7, the process proceeds to step S8, and the collection agent who transmits the first acceptance answer is decided as the collection agent (assigned collection agent) who accepts the spot collection request.

In this way, the spot collection request information is transmitted to the plurality of collection agents A to C decided by the management server 2 and the manager terminal 3 (steps S1 to S6), and the collection agent who first answers to accept the spot collection request is decided as the assigned collection agent (step S7 and S8), whereby the spot collection request can be reliably processed. That is, it is possible to decide the collection agent who can reliably visit the spot collection destination. Next, in step S9, by the processing of the information output unit 206, the processing status of the spot collection request including the information of the assigned collection agent decided by the collection destination assignment unit 205 is transmitted to all the collection agent terminals 1A to 1C to which the spot collection request information is transmitted. Accordingly, the processing status of the spot collection request is shared with all the collection agents A to C to which the spot collection request is transmitted, and the collection agent A to C can grasp the processing status of the request, for example, confirms that the request is accepted by oneself or the request is accepted by other collection agent.

<Manager Terminal 3>

Next, the manager terminal 3 will be described. The manager terminal 3 is used by the manager of the delivery base to manage the collection agent who visits the collection destination. The manager terminal 3 includes various computers such as a personal computer, a tablet type terminal, and a smart phone installed in a delivery base, and transmits and receives information to and from the management server 2 through the network 4.

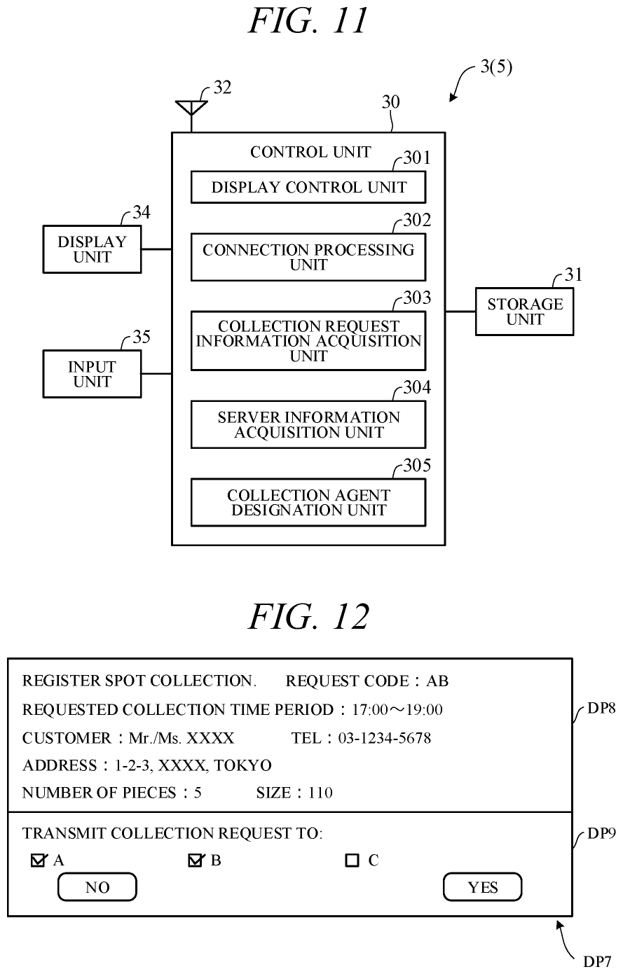

FIG. 11 is a block diagram illustrating a schematic configuration of the manager terminal 3. As illustrated in FIG. 11, the manager terminal 3 includes a control unit 30, a storage unit 31, a communication unit 32, a display unit 34, and an input unit 35.

The storage unit 31 includes a semiconductor memory, a hard disk drive, and the like. The storage unit 31 stores an operating system (OS), software called an application, and various kinds of other information.

The communication unit 32 implements a communication protocol capable of performing wired communication (for example, Internet lines) or wireless communication such as 3G, LTE, 4G, and 5G, and is connected to the management server 2 to transmit and receive various kinds of data.

The display unit 34 is configured by a display device such as a liquid crystal display or an organic EL panel. In response to an instruction from the control unit 30, the display unit 34 displays a map, an icon of an operation button for a touch panel, and the like and displays various and displays a collection agent designation screen and a request status check screen at the time of requesting a spot collection. Further, the display unit 34 can display the candidates of the collection agents A to C to whom the spot collection request information is to be transmitted on the basis of the information (information transmitted in step S4) transmitted from the information output unit 206 of the management server 2 (collection agent designation screen).

FIG. 12 is a diagram illustrating an example of the collection agent designation screen. As illustrated in FIG. 12, the collection agent designation screen DP7 is displayed as a modal window. The name, address, and telephone number of the spot collection destination, collection contents, and a designated time period are displayed on a request content display part DP8 at the upper part of the collection agent designation screen DP7. In a collection agent designation part DP9 at the lower part of a collection agent designation screen DP7, the candidate collection agents A to C selected by the management server 2 are displayed in the order that the representative position is closer to the address of the spot collection destination, and check boxes are displayed corresponding to the displayed collection agents.

The input unit 35 includes a physical switch such as a numeric keypad operated by the manager and an input device (not illustrated) such as a touch panel superimposed on the display surface of the display unit 34. A switching command of the display screen of the display unit 34 is inputted through the input unit 35. The transmission destination collection agent can be designated via the input unit 35. In other words, through the input unit 35, a selection command can be input into the check box on the collection agent designation screen DP7 of FIG. 12.

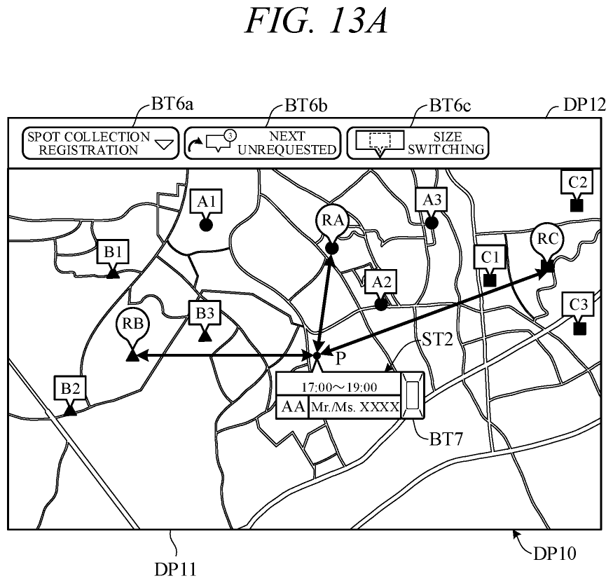

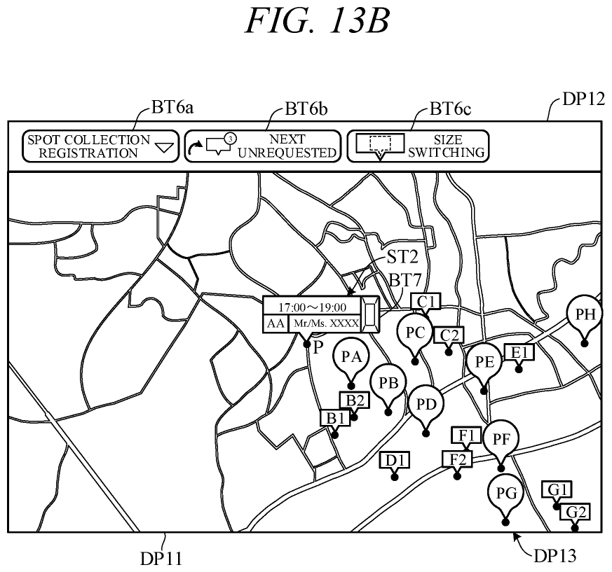

FIG. 13A is a diagram illustrating another example of the collection agent designation screen. As illustrated in FIG. 13A, a peripheral map DP11 of the spot collection destination P is displayed on the collection agent designation screen DP10. Further, a menu screen DP12 is displayed on the upper part of the peripheral map DP11. On the menu screen DP12, menu buttons BT6a to BT6c such as “spot collection registration”, “next unrequested” and “size switching” are displayed to be selectable. The designation of the assigned collection agent can be input by pressing drop pins RA to RC indicating the representative position on the peripheral map DP11 of the collection agent designation screen DP10 through the input unit 35 (touch panel). The collection agent designation screen DP7 by the modal window of FIG. 12 may be superimposed on the collection agent designation screen DP10 on the map display of FIG. 13A. By displaying the collection agent designation screen DP10 on the map, the manager who designates the collection agent can intuitively grasp the peripheral statuses of the collection agent and the spot collection destination P.

FIG. 13B is a diagram illustrating a modification of the collection agent designation screen using the map display of FIG. 13A, and is a diagram illustrating an example of the collection agent designation screen DP13 in a case where the manager of the delivery base designates the collection agent to be sent a request for spot collection by oneself. As illustrated in FIG. 13B, drop pins PA to PH indicating the current positions of the collection agents (eight collection agents A to H in the drawing) around the spot collection destination P and drop pins (B1 to G2 in the drawing) indicating the responsible collection destinations of each collection agent are displayed on the peripheral map DP11 of the spot collection destination P in the collection agent designation screen DP13. The designation of the collection agent to be sent a request for spot collection can be input through the input unit 35 (touch panel) by pressing the drop pins PA to PH indicating the current positions on the peripheral map DP11.

As illustrated in FIGS. 13A and 13B, the collection agent designation screens DP10 and DP13 display the spot collection destination P and a drop pin ST2 indicating the processing status of the spot collection request or the like.

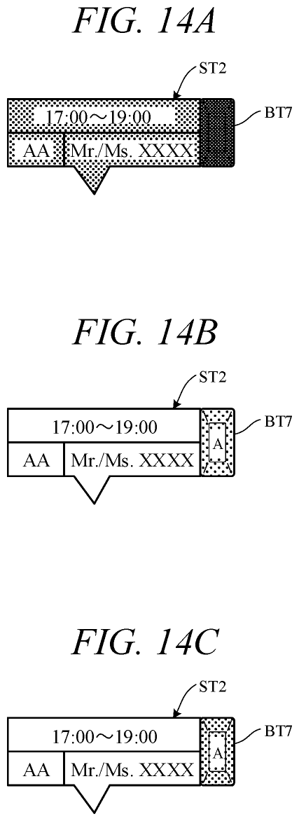

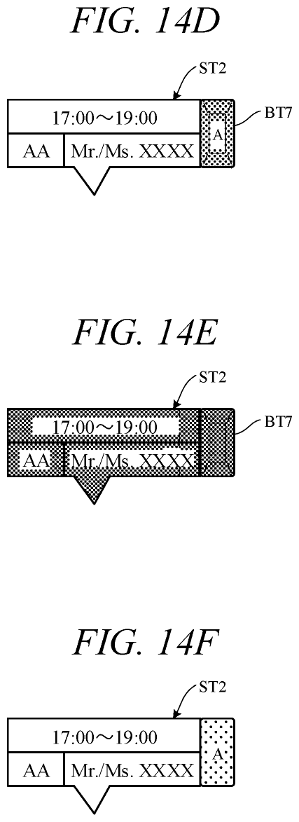

FIGS. 14A to 14F are diagrams illustrating examples of the status display in the collection agent designation screens DP10 and DP13 of FIGS. 13A and 13B. The drop pin ST2 in FIG. 14A is a status display displayed when spot collection is not requested to the collection agent yet. A button BT7 is displayed to be selectable on the drop pin ST2 in FIG. 14A. When the button BT7 is pressed, in the collection agent designation screens DP10 and DP13 in FIGS. 10A and 13B, the drop pins RA to RC and PA to PH are pressed to enter a standby state in which the collection agent to be sent a request for spot collection can be designated (input).

The drop pin ST2 in FIG. 14B is the status display which is displayed when the spot collection is requested to the collection agents, but no collection agents requested for spot collection check the request. The drop pin ST2 in FIG. 14C is the status display which is displayed when at least one of the collection agents requested for spot collection checks the request, but no answer to the request is transmitted by anyone. The drop pin ST2 in FIG. 14D is the status display which is displayed when a predetermined period of time (for example, fifteen minutes) elapses without any one of the collection agents requested for spot collection answering to the request. The button BT7 is displayed to be selectable on the drop pins ST2 of FIGS. 14B to 14D, and further the collection agent (A in the drawing) who has been requested for spot collection is superimposed on the button BT7.

The drop pin ST2 in FIG. 14E is the status display which is displayed when all the collection agents requested for spot collection answer that the collection agents cannot accept the request. Also on the drop pin ST2 of FIG. 14E, the button BT7 similar to that of the drop pin ST2 of FIG. 14A is displayed to be selectable.

The drop pin ST2 of FIG. 14F is the status display which is displayed when the collection agent who accepts the spot collection has been confirmed. The drop pin ST2 of FIG. 14F displays the collection agent (A in the drawing) who confirms the acceptance of the request. The drop pin ST2 is hidden when the spot collection is completed.

The drop pins ST2 of FIGS. 14A to 14F are each displayed with a background color of a different shade. The manager who requests the spot collection can easily grasp the processing status of whether the requested collection agent checks the spot collection request requested by the manager or which collection agent accepts the request by checking the drop pins ST2 of the collection agent designation screens DP10 and DP13.

The screen display of the collection agent designation screens DP10 and DP13 of FIGS. 13A and 13B can be switched to the screen displays corresponding to the menu buttons BT6a to BT6c by pressing the respective menu buttons BT6a to BT6c on the menu screen DP12. Specifically, when the menu button BT6a of “spot collection registration” is pressed, the screen is switched to a screen for registering a new spot collection. When the menu button BT6b of “next unrequested” is pressed, for the spot collection not yet requested to the collection agent, the screen is switched to a screen for displaying the peripheral map DP11 of the spot collection destination P thereof in the registration order. Further, when the menu button BT6c of “size switching” is pressed, the display sizes of all the drop pins ST2 are changed at once. The menu button BT6b of “next unrequested” displays the number of spot collection requests not yet requested to the collection agent.

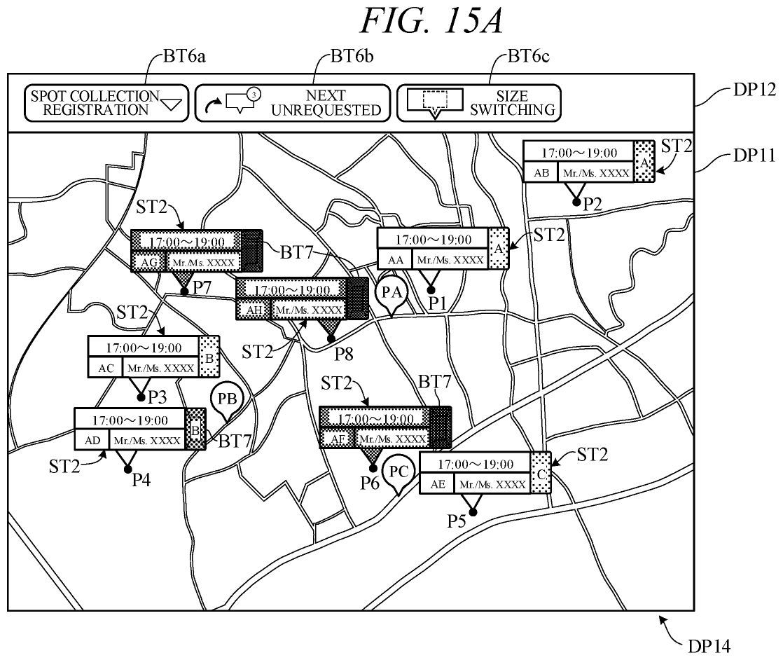

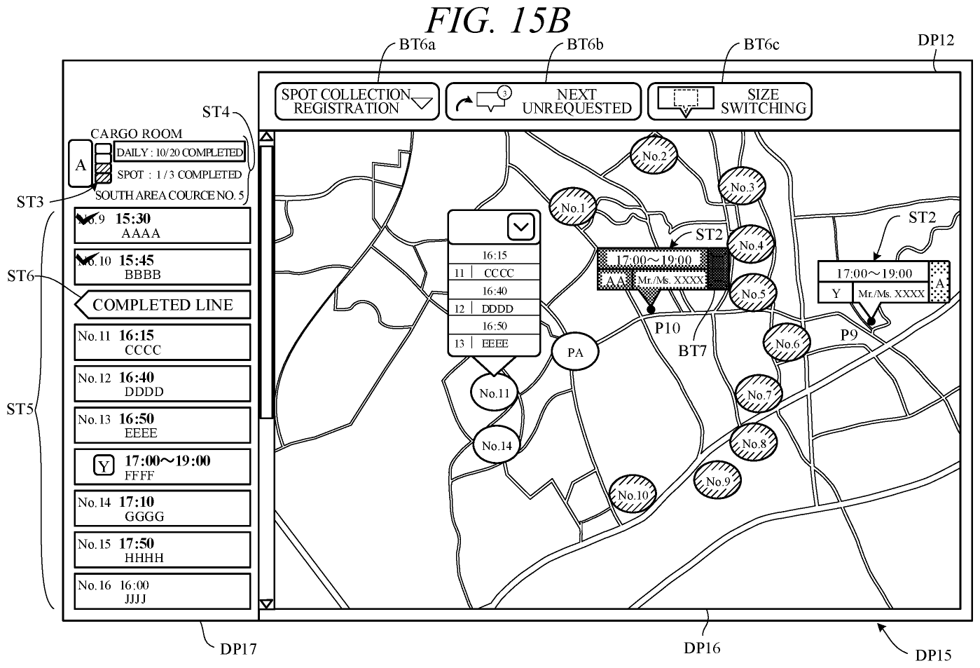

FIG. 15A is a diagram illustrating an example of the request status check screen, and is a diagram illustrating an example of a request status check screen DP14 in a case where all the collection destinations of spot collection not yet requested to the collection agent are displayed. As illustrated in FIG. 15A, peripheral spot collection destinations P1 to P8 including the number (three in the drawing), which is displayed on the menu button BT6b of the “next unrequested” of the menu screen DP12, of unrequested spot collection destinations P6 to P8 are displayed on the peripheral map DP11. The peripheral map DP11 also displays the drop pins PA to PC indicating the current positions of the peripheral collection agents (three collection agents A to C in the drawing) and the drop pins ST2 indicating unrequested spot collection destinations P6 to P8. When the button BT7 of each drop pin ST2 is pressed, the screen display can be switched to a collection agent designation screen for requesting the spot collection for the spot collection destination P1 to P8 corresponding to each drop pin ST2. The manager requesting the spot collection can easily grasp the positions of the unrequested spot collection destinations P6 to P8 and the current positions of the surrounding collection agents A to C by checking the request status check screen DP14.

FIG. 15B is a diagram illustrating another example of the request status check screen, and is a diagram illustrating an example of a request status check screen DP15 in the case of displaying the request status for a specific collection agent (A in the drawing). As illustrated in FIG. 15B, the request status check screen DP15 displays a peripheral map DP16 of the collection agent A. The icons indicating the positions of the spot collection destinations P1 to P14 in which the collection agent A is responsible for the collection are displayed on the peripheral map DP16 of the collection agent A. The icons indicating the positions of the spot collection destinations P1 to P10 of the complete collections and the icons indicating the positions of the spot collection destinations P11 to P14 of the incomplete collections are displayed with different background colors or the like. The positions of the spot collection destinations P11 to P 13 in the same building are collectively displayed by one icon. The peripheral spot collection destination is also displayed on the peripheral map DP16 of the collection agent A. In FIG. 15B, drop pins ST2 are displayed to indicate the spot collection destination P9 which is confirmed to be accepted by the collection agent A and the spot collection destination P10 not yet requested by the collection agent.

The request status check screen DP15 further displays a collection status screen DP17 indicating the progress status of collection by the collection agent A. In addition to the progress status of collection, the collection status screen DP17 displays the cargo room status ST3, which is transmitted from the collection agent terminal 1A to the management server 2 and is used by the collection agent A, of the vehicle 6A. The cargo room status indicates four stages of the status of the cargo room such as a situation in which the cargo room is full and no more collection is acceptable (100%), a situation in which a few more collection is acceptable (90%), a situation in which the cargo room is still a margin (60%), and a situation in which the cargo room is almost empty (30%) (60% in the drawing). The progress status of the collection in the collection status screen DP17 is displayed as the number of completed collections for each of daily collection and spot collection (status display ST4) and also as a list of collection requests in time series (status display ST5). In the status display ST5, the collection destinations are displayed in time series according to the designated time of the collection request, and an icon ST6 indicating a completion line is displayed between the display of the collection destinations (No. 9, No. 10) of the complete collections and the display of the collection destinations (No. 11 to No. 13, Y, No. 14 to No. 16) of the incomplete collections.

When the button BT7 of the drop pin ST2 indicating the unrequested spot collection destination P10 is pressed, the screen display can be switched to a collection agent designation screen for requesting the spot collection for the spot collection destination P10. The manager requesting the spot collection can check the progress status of the collection, the moving route, the current position, and the like of the specific collection agent A by checking the request status check screen DP15, and thus, the manager can request the spot collection by designating the collection agent A after examining whether the collection agent A is able to accept an additional spot collection.

Returning to the description of FIG. 11, the control unit 30 includes a processor having a CPU, a RAM, a ROM, an I/O, and the like. The control unit 30 has, as a functional configuration, a display control unit 301, a connection processing unit 302, a collection request information acquisition unit 303, a server information acquisition unit 304, and a collection agent designation unit 305.

The display control unit 301 generates an image signal in response to the operation of the input unit 35 or in response to the reception of the selection result or the like of the candidate collection agent by the communication unit 32, and transmits the image signal to the display unit 34 to control the screen display by the display unit 34. The screen displayed on the display unit 34 by the display control unit 301 includes a login screen for logging in to the request processing system 100, a spot collection registration screen for inputting spot collection request information and transmitting the information to the management server 2, a collection agent designation screen (DP 7, DP10, DP13) for displaying the selection result of the candidate collection agent received from the management server 2 and designating the collection agents to whom a spot collection is to be requested, and a request status check screen (DP14, DP15) for checking the request status of the spot collection.

The connection processing unit 302 executes login processing to the management server 2 by using, for example, an identification number (base manager ID) for identifying the delivery base (manager or responsible person) and a password.

A collection request information acquisition unit 303 acquires the spot collection request information which is received by the manager from the customer through the window of the delivery base, a telephone, the Internet, and the like to be inputted through the input unit 35 and stored in the storage unit 31. The collection request information acquisition unit 303 transmits the spot collection request information to the management server 2 through the communication unit 32. The spot collection request information includes the address (residence indication, latitude, longitude) or the telephone number of the spot collection destination, collection contents, a designated time period, and the like.

In response to a request from the manager terminal 3, the server information acquisition unit 304 acquires the information transmitted from the management server 2 (the information output unit 206 and the like), for example, the selection result of the candidate collection agents A and B to which the spot collection request is to be transmitted.

In response to the command from the manager, the collection agent designation unit 305 designates the collection agents A and B to whom the spot collection request is to be transmitted among the candidate collection agents A and B selected by the management server 2. For example, the assigned collection agent commanded through the input unit 35 is designated on the basis of the operation evaluation information of the collection agent, the traffic situation around the spot collection destination, and the like. When a plurality of collection agents are designated as the transmission destination collection agent, the spot collection request can be processed more reliably. The transmission destination collection agent designated by the collection agent designation unit 305 is transmitted through the communication unit 32 to the management server 2. Incidentally, in a case where the transmission destination collection agent is not designated within a predetermined time, all the candidate collection agents A and B selected by the management server 2 may be automatically designated.

[Operation of Request Processing System 100]Next, an example of the operation of the request processing system 100 will be described. Hereinafter, the operation on the collection agent C in addition to the collection agents A and B illustrated in FIG. 1 will be described. The collection agent C also has a collection agent terminal 1C similar to the collection agents A and B. The collection agents A to C are assigned daily collection destinations in advance as illustrated in FIG. 13A. That is, A1 to A3, B1 to B3, and C1 to C3 are assigned as daily collection destinations to the collection agent A, B, and C, respectively.

For example, at the time of departure from the delivery base, that is, at the start of business, the collection agents A to C input their own logins ID and passwords through the input units 15 on the login screens displayed on the display units 14 of the collection agent terminals 1A to 1C, respectively. When this input is made, the management server 2 performs connection processing with the collection agent terminals 1A to 1C. Thereafter, the collection agent terminals 1A to 1C communicate with the management server 2 at a predetermined time interval (for example, every three seconds), and for example, transmit the position information of the collection agents A to C to the management server 2. The communication between the collection agent terminals 1A to 1C and the management server 2 is continued until the collection agent terminals 1A to 1C perform logout operation.

On the other hand, the manager of the delivery base inputs the base manager ID and the password on the login screen displayed on the display unit 34 of the manager terminal 3 through the input unit 35. When this input is made, the management server 2 performs connection processing with the manager terminal 3. The manager receives a spot collection request from the customer through the window of the delivery base, the telephone, the Internet, and the like and operates the manager terminal 3 to input spot collection request information on the spot collection registration screen. In response to this input, the management server 2 selects, for example, two candidate collection agents A and B in the order that the representative position (for example, RA, RB, and RC in FIG. 13A) in the time period designated in the spot collection request is close to the address (for example, P in FIG. 13A) of the spot collection destination, and transmits the selection result to the manager terminal 3 (steps S1 to S4).

When receiving the selection results of the candidate collection agents A and B from the management server 2, the manager terminal 3 displays the collection agent designation screens DP7 and DP10 including the selection result on the display unit 34 (FIGS. 12 and 13A). When the manager operates on the check box of the collection agent designation screen DP7 through the input unit 35 (touch panel) or presses the representative position of the collection agent designation screen DP10 to designate, for example, the collection agents A and B, that is, when the collection agents A and B are designated as transmission destination collection agents, the manager terminal 3 transmits the designation result to the management server 2 (step S5). When receiving the designation result of the collection agents A and B from the manager terminal 3, the management server 2 decides the collection agents A and B as the collection agents to whom the spot collection request information is to be transmitted, and transmits the spot collection request information to the collection agent terminals 1A and 1B of the collection agents A and B (step S6).

When receiving the spot collection request information, the collection agent terminals 1A and 1B, for example, vibrate the collection agent terminals 1A and 1B to notify the collection agents A and B that the spot collection request information is received. At this time, the collection agent terminals 1A and 1B display the received spot collection request information on the display units 14 (FIGS. 3 to 5). With reference to the request content display part DP3 of the request answer screen DP2 displayed on the display unit 14, each of the collection agents A and B presses the request answer button BT3 or BT4 of “accept” or “unacceptable” in the request answer input part DP4 of the request answer screen DP2 through the input unit 15 (touch panel) to input a response of whether or not to accept the spot collection request. Accordingly, the collection agent terminals 1A and 1B transmit the answer to the management server 2 (step S7).

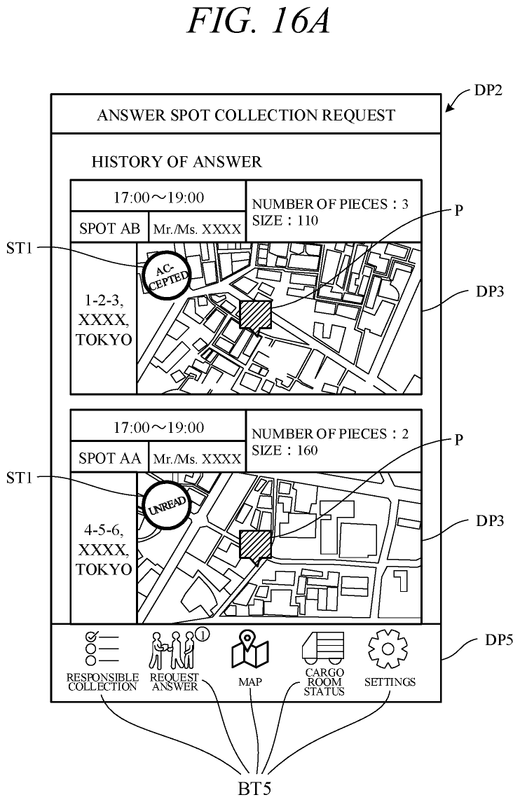

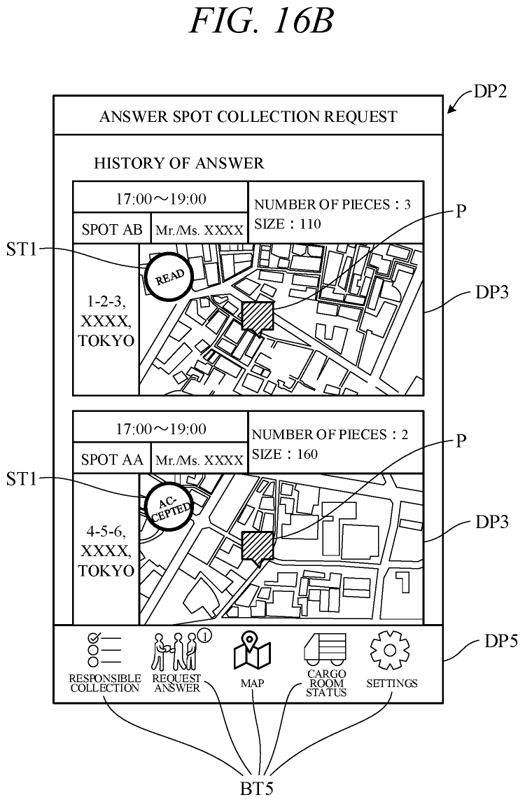

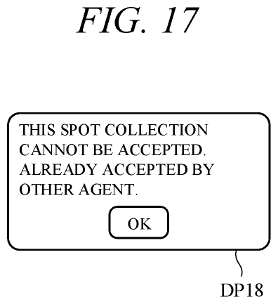

FIGS. 16A and 16B are diagrams illustrating an example of the request answer screens DP2 of the collection agent terminals 1A and 1B after answering to the spot collection request, respectively, and FIG. 17 is a diagram illustrating an example of the screen display of the collection agent terminal 1B when the spot collection request cannot be accepted. In a case where the collection agent A transmits an answer to the spot collection request (request code AB) first, the collection agent A decides to accept the spot collection request (request code AB), and notifies the fact to the collection agent terminals 1A and 1B so that the fact is displayed as a history on the request answer screen DP2 of the display unit 14 (steps S7 to S9). As illustrated in FIG. 16A, on the display unit 14 of the collection agent terminal 1A, the processing status ST1 of the spot collection request (request code AB) is displayed as “accepted” to be superimposed on the request content display part DP3 of the request answer screen DP2.

On the other hand, in a case where the collection agent A accepts the request in advance after the collection agent B checks the request contents of the spot collection request (request code AB), on the display unit 14 of the collection agent terminal 1B, a message DP18 indicating that other collection agent already accepts the spot collection request is displayed as illustrated in FIG. 17. Further, as illustrated in FIG. 16B, on the request answer screen DP2 of the collection agent terminal 1B, the processing status ST1 of the spot collection request (request code AB) is displayed as “read” on the request content display part DP3.

In a case where the collection agent B transmits an answer to the spot collection request (request code AA) first, the collection agent B decides to accept the spot collection request (request code AA), and notifies the fact to the collection agent terminals 1A and 1B so that the fact is displayed as a history on the request answer screen DP2 of the display unit 14 (steps S7 to S9). As illustrated in FIG. 16B, on the display unit 14 of the collection agent terminal 1B, the processing status ST1 of the spot collection request (request code AB) is displayed as “accepted” to be superimposed on the request content display part DP3 of the request answer screen DP2. On the other hand, in a case where the collection agent B accepts the spot collection request (request code AA) before the collection agent A checks the request contents of the request, on the display unit 14 of the collection agent terminal 1A, the processing status ST1 of the spot collection request (request code AA) is displayed as “unread” on the request content display part DP3 as illustrated in FIG. 16A.

Incidentally, although not illustrated, in the history display of the request answer screen DP2 displayed on the display unit 14, for example, when the collection agents A and B scroll the screen through the input unit 15 (touch panel), the processing statuses of all the spot collection requests received by the respective collection agent terminals 1A and 1B can be displayed. In the example of FIGS. 16A and 16B, in the case of actually accepting the spot collection request after answering to accept the spot collection request, “accepted” is displayed to be superimposed on the request content display part DP3 as the processing status ST1. However, similarly, in the case of already answering not to accept the spot collection request, “cannot respond” is displayed as the processing state ST1 to be superimposed on the request content display part DP3. Accordingly, the collection agents A and B can grasp the processing status of the spot collection request received by oneself. For example, even in a case where the spot collection request cannot be answered immediately while driving, it is possible to easily grasp a status where other collection agent already accepts the request, or no one accepts the request yet.

Accordingly, the information of the spot collection request received by the manager of the delivery base is transmitted to the plurality of collection agents A and B, and the collection agent A accepting the spot collection request is decided in consideration of the answers from the collection agents A and B. Thus, the spot collection request from the customer can be quickly and reliably processed.

Incidentally, when it is decided that the collection agent A accepts the spot collection request, the management server 2 can also update the representative position or the like of the collection agent A in the designated time period of the spot collection request. Accordingly, the representative position of the collection agent A managed by the management server 2 becomes a more accurate position. Further, in a case where the requester of the previous spot collection makes an additional spot request in the same designated time period, the representative position of the collection agent A to which the previous spot collection request is assigned is updated as a position closer to the spot collection destination. Accordingly, a possibility that the additional spot collection request is assigned to the same collection agent A is increased, and the collection can be performed efficiently.

The present embodiment can achieve advantages and effects such as the following:

(1) The request processing system 100 includes: the management device 5 configured to receive spot collection requests from customers in response to instruction of the manager and to assign the request to collection agents A, B; and the collection agent terminal 1A, 1B carried by each of the collection agents A, B (FIG. 1B). The management device 5 includes: the information acquisition unit 202 and the collection request information acquisition unit 303 configured to acquire the spot collection request information; the collection destination assignment unit 205 configured to assign the spot collection request to the agents A, B when the spot collection request information is acquired by the information acquisition unit 202 and the collection request information acquisition unit 303; and the information output unit 206 configured to transmit the spot collection request information to the collection agent terminals 1A, 1B of the collection agents A, B to whom the spot collection request is assigned by the collection destination assignment unit 205 (FIG. 4, FIG. 6). The collection agent terminal 1A, 1B includes: the display unit 14 configured to notify the spot collection request information transmitted by the information output unit 206; the input unit 15 configured to input the answer as to whether the spot collection request included in the spot collection request information notified by the display unit 14 is accepted; and the request answer notification unit 105 configured to transmit the answer inputted by the input unit 15 to the management device 5 (FIG. 2). The collection destination assignment unit 205 decides the collection agent A who accepts the spot collection request based on the answer transmitted by the request answer notification unit 105.

With this configuration, the information of the request is transmitted to a plurality of service staff and, in consideration of the answers from the service staff, one of the service staff who accepts the request is decided. Thus, the request from the customer can be processed quickly and reliably.

(2) When the collection agent A who accepts the spot collection request is decided by the collection destination assignment unit 205, the information output unit 206 transmits the decision information to the collection agent terminals 1A, 1B. Specifically, the processing status of the spot collection request is shared among all the collection agents A, B who answered whether to accept the spot collection request. Accordingly, each of the service staff who receives the request can grasp the request processing status such as whether acceptance of the request by oneself has been confirmed or the request has been accepted by another of the service staff

(3) The collection destination assignment unit 205 decides the collection agent A who answered that the spot collection request is accepted through the request answer notification unit 105 first, as the collection agent who accepts the spot collection request. Accordingly, the system configuration can be simplified, and the request can be quickly processed.

(4) The collection agent terminal 1A, 1B further includes: check buttons BT1, BT2 configured to input answer timing whether to answer the spot collection request from the customer immediately or later (FIG. 3). Accordingly, it is possible to inform the manager that the answer will be given later when the collection agents A and B are working at the collection destination.

(5) The display unit 14 notifies the spot collection request information transmitted by the information output unit 206 at a predetermined time period until the answer timing is inputted through the check buttons BT1, BT2 of the collection agent terminals 1A, 1B of the collection agents A, B to whom the spot collection request from the customer is assigned. Accordingly, it is possible to reliably have the collection agents A and B recognize the arrival of the spot collection request.

(6) The display unit 14 changes enhancement degree for notifying the spot collection request information transmitted by the information output unit 206 in accordance with the number of notifications of the spot collection request information transmitted by the information output unit 206 or the time period until the designated time designated in the spot collection request. Accordingly, it is possible to have the collection agents A and B recognize the arrival of the spot collection request more reliably.

(7) The input unit 15 is configured as the request answer buttons BT3, BT4 on the display unit 14 (FIG. 5). The input unit 15 for inputting an answer to the spot collection request is configured as request answer buttons BT3 and BT4 on the display unit 14 on which the information of the spot collection request is displayed. Thus, the collection agents A and B can input an answer to the request with a simple operation while checking the information of the spot collection request.

(8) The display unit 14 displays the processing status ST1 of the spot collection request from the customer including the answer status to the spot collection request from the customer together with the spot collection request information transmitted by the information output unit 206 (FIG. 5, FIG. 6A to FIG. 6D, FIG. 16A, FIG. 16B). Accordingly, the collection agents A and B can easily grasp the processing status of the spot collection request assigned to oneself.

(9) The processing status ST1 includes: a status where the collection agent A, B carrying the collection agent terminal 1A, 1B is decided as the collection agent who accepts the spot collection request from the customer (FIG. 6A); a status where the collection agent A, B carrying the collection agent terminal 1A, 1B answered that the spot collection request from the customer cannot be accepted (FIG. 6B); a status where the collection agent other than the collection agent A, B carrying the collection agent terminal 1A, 1B was decided as the collection agent who accepts the spot collection request from the customer before the collection agent A, B carrying the collection agent terminal 1A, 1B answers the spot collection request from the customer (FIG. 6C); and a status where the collection agent other than the collection agent A, B carrying the collection agent terminal 1A, 1B is decided as the collection agent who accepts the spot collection request from the customer after the collection agent A, B carrying the collection agent terminal 1A, 1B answered the spot collection request from the customer (FIG. 6D). Thus, the collection agents A and B can easily identify the processing status of the spot collection request assigned to oneself as an object on the request answer screen DP2 of the collection agent terminals 1A and 1B and can grasp the processing status more easily.

(10) The management device 5 further includes: the display unit 34 configured to display the drop pin ST2 indicating the request status of the spot collection request from the customer (FIG. 11, FIG. 13A to FIG. 15B). The drop pin ST2 indicating the request status includes: a status where the spot collection request from the customer has not been assigned to the collection agents A, B by the collection destination assignment unit 205 (FIG.14A); a status where none of the collection agents A, B to whom the spot collection request from the customer was assigned has answered as to whether the spot collection request from the customer is accepted after the spot collection request from the customer was assigned to the collection agents A, B by the collection destination assignment unit 205 (FIG. 13B to FIG. 14D); and a status where the collection agent who accepts the spot collection request from the customer has been decided by the collection destination assignment unit 205 (FIG. 14F). Accordingly, the manager can grasp various kinds of status information related to the spot collection request, that is, the status of the position and number of spot collection requests from the customer, the status (unassigned or assigned) of the spot collection request to the collection agent, and the status (unaccepted or accepted) of the answer from the collection agent to the spot collection request on the collection agent designation screen by the map display.

Incidentally, the above-described embodiment may be modified into various forms. Hereinafter, a modification will be described. In the above-described embodiment, the management device 5 receives the spot collection request in response to the instruction of the manager and assigns the spot collection request to a plurality of collection agents A and B. However, the configuration of the management device which receives the request and assigns a plurality of service staff the request to be handled is not limited to the above-described configuration. For example, the invention can be applied to requests to ride sharing, part-time or part-time work, side work, and the like.

In the above-described embodiment, the representative latitude/longitude calculation unit 204 calculates the average values of the latitude and longitude of the daily collection destination. However, for example, the direction and distance viewed from the delivery base may be used instead of the latitude and longitude.

In the above-described embodiment, the collection request information acquisition unit 303 of the manager terminal 3 acquires the spot collection request information input through the input unit 35 or stored in the storage unit 31 and transmits the information to the management server 2, and the information acquisition unit 202 of the management server 2 acquires the transmitted spot collection request information. However, the configuration of the request information acquisition unit which acquires the information of the request is not limited thereto. For example, the information acquisition unit 202 of the management server 2 may be configured to directly receive the spot collection request information which the requester of the spot collection transmits through the own smartphone or personal computer.

In the above-described embodiment, the collection destination assignment unit 205 selects a plurality of collection agents A and B in the order in which the representative position in the designated time period is closer to the spot collection destination and assigns the spot collection request to the collection agents. However, the configuration of the service staff assigning unit for assigning the request of the customer to a plurality of service staff is not limited thereto. For example, the request may be assigned to a plurality of collection agents of which the spot collection destinations are included within a predetermined range around the representative position in the designated time period.

In the above-described embodiment, the collection agent designation unit 305 designates the collection agents A and B to whom the spot collection request is to be assigned among the collection agents A and B selected by the management server 2. However, a collection agent other than the collection agents A and B selected by the management server 2 may be designated.

In the above-described embodiment, the display unit 14 displays the spot collection request information, the processing status thereof, and the like. However, the configuration of the information notification unit for notifying the requested information is not limited to this, and the notification may be performed by, for example, sound, vibration, lighting or flashing of a light in addition to the screen display.

In the above-described embodiment, the display contents of the processing status of the spot collection request transmitted by the information output unit 206 to the collection agent terminals 1A and 1B is exemplified in some diagrams including FIGS. 16A and 16B. However, the configuration of the information transmission unit, which transmits decision information to a plurality of portable terminals when one of the service staff who accepts the request of the customer is decided, is not limited thereto.

The above description is only an example, and the present invention is not limited to the above embodiment and modifications, unless impairing features of the present invention. The above embodiment can be combined as desired with one or more of the above modifications. The modifications can also be combined with one another.

### REFERENCE SIGNS LIST

1A, 1B collection agent terminal, 2 management server, 3 manager terminal, 4 network, 5 management device, 6A, 6B vehicle, 10 control unit, 11 storage unit, 12 wireless unit, 13 sensor unit, 13a GPS sensor, 13b gyro sensor, 14 display unit, 15 input unit, 20 control unit, 21 storage unit, 22 communication unit, 24 display unit, 25 input unit, 30 control unit, 31 storage unit, 32 communication unit, 34 display unit, 35 input unit, 100 request processing system, 101 display control unit, 102 connection processing unit, 103 position information notification unit, 104 cargo room status notification unit, 105 request answer notification unit, 201 connection processing unit, 202 information acquisition unit, 203 collection destination information registration unit, 204 representative latitude/longitude calculation unit, 205 collection destination assignment unit, 206 information output unit, 211 collection agent information area, 212 vehicle information area, 213 collection destination information area, 214 map information area, 301 display control unit, 302 connection processing unit, 303 collection request information acquisition unit, 304 server information acquisition unit, 305 collection agent designation unit.

1. A request processing system, comprising:
a management device configured to receive a request from a customer in response to an instruction of a manager and to assign the request to a plurality of agents; and
a portable terminal carried by each of the plurality of agents, wherein the management device includes:
a first microprocessor and a first memory coupled to the first microprocessor,
wherein
the first microprocessor is configured to function as:
a request information acquisition unit configured to acquire second request information of a second request including information of a visiting position and a visiting time period, the second request information being different from first request information of a pre-assigned first request;
a representative latitude/longitude calculation unit configured to calculate a representative position in each visiting time period for each of the plurality of agents based on the first request information every time the first request information is corrected;
an agent assignment unit configured to assign the second request to the plurality of agents based on the representative position calculated by the representative latitude/longitude calculation unit; and
an information transmission unit configured to transmit the second request information to the portable terminal of the plurality of agents to whom the second request is assigned by the agent assignment unit, wherein the portable terminal includes:
a display unit configured to notify the second request information transmitted by the information transmission unit;
an answer input unit configured to input an answer as to whether the second request from the customer included in the second request information notified by the display unit is accepted; and
a second microprocessor and a second memory coupled to the second microprocessor, wherein
the second microprocessor is configured to function as:
an answer transmission unit configured to transmit the answer inputted by the answer input unit to the management device, wherein
the agent assignment unit decides an agent of the plurality who accepts the second request based on the answer transmitted by the answer transmission unit, wherein
the display unit displays the request information transmitted by the information transmission unit, wherein
the display unit displays a processing status of the request from the customer including an answer status to the request from the customer on the request information transmitted by the information transmission unit.

2. The request processing system according to claim 1, wherein
when the agent who accepts the request from the customer is decided by the agent assignment unit, the information transmission unit transmits decision information to the portable terminal of the plurality of agents.

3. The request processing system according to claim 1, wherein
the agent assignment unit decides the agent who answered that the request from the customer is accepted through the answer transmission unit first, as the agent who accepts the request from the customer.

4. The request processing system according to claim 1, wherein
the portable terminal further includes:
an answer timing input unit configured to input an answer timing whether to answer the request from the customer immediately or later.

5. The request processing system according to claim 4, wherein
the display unit notifies the request information transmitted by the information transmission unit at a predetermined time period until the answer timing is inputted through the answer timing input unit of the portable terminal of the plurality of agents to whom the request from the customer is assigned.

6. The request processing system according to claim 5, wherein
the display unit changes an enhancement degree for notifying the request information transmitted by the information transmission unit in accordance with a number of notifications of the request information transmitted by the information transmission unit or a time period until a designated time designated in the request from the customer.

7. The request processing system according to claim 1, wherein
the answer input unit is configured as a button on the display unit.

8. (canceled)

9. The request processing system according to claim 1, wherein
the processing status includes:
a status where the agent carrying the portable terminal is decided as the agent who accepts the request from the customer;
a status where the agent carrying the portable terminal answered that the request from the customer cannot be accepted;
a status where the agent other than the agent carrying the portable terminal was decided as the agent who accepts the request from the customer before the agent carrying the portable terminal answers the request from the customer; and
a status where the agent other than the agent carrying the portable terminal is decided as the agent who accepts the request from the customer after the agent carrying the portable terminal answered the request from the customer.

10. The request processing system according to claim 1, wherein
the management device further includes:
a display unit configured to display a request status of the request from the customer, wherein
the request status includes:
a status where the request from the customer has not been assigned to the plurality of agents by the agent assignment unit;
a status where none of the plurality of agents to whom the request from the customer was assigned has answered as to whether the request from the customer is accepted after the request from the customer was assigned to the plurality of agents by the agent assignment unit; and
a status where the agent who accepts the request from the customer has been decided by the agent assignment unit.

11. The request processing system according to claim 1, wherein
the request from the customer is a collection request.

12. The request processing system according to claim 1, wherein
the request from the customer is a vehicle allocation request.

13. A request processing system, comprising:
a management device configured to receive a request from a customer in response to an instruction of a manager, and to assign the request to a plurality of agents; and
a portable terminal carried by each of the plurality of agents, wherein
the management device includes:
a first microprocessor and a first memory coupled to the first microprocessor, wherein
the first microprocessor is configured to perform:
acquiring second request information of a second request including information of a visiting position and a visiting time period, the second request information being different from first request information of a pre-assigned first request;
calculating a representative position in each visiting time period for each of the plurality of agents based on the first request information every time the first request information is corrected;
assigning the second request to the plurality of agents based on the representative position calculated; and
transmitting the second request information to the portable terminal of the plurality of agents to whom the second request is assigned, wherein the portable terminal includes:
a display unit configured to notify the second request information transmitted;
an answer input unit configured to input an answer as to whether the second request from the customer included in the second request information notified by the display unit is accepted; and
a second microprocessor and a second memory coupled to the second microprocessor, wherein
the second microprocessor is configured to perform:
transmitting the answer inputted by the answer input unit to the management device, wherein
the first microprocessor is configured to perform:
the assigning including deciding an agent of the plurality who accepts the second request based on the answer transmitted, wherein
the display unit displays the request information transmitted, wherein
the display unit displays a processing status of the request from the customer including an answer status to the request from the customer on the request information transmitted.

14. The request processing system according to claim 13, wherein
the first microprocessor is configured to perform:
the second request information transmitting including, when the agent who accepts the request from the customer is decided, transmitting decision information to the portable terminal of the plurality of agents.

15. The request processing system according to claim 13, wherein the first microprocessor is configured to perform:
the assigning including deciding the agent who answered that the request from the customer is accepted first, as the agent who accepts the request from the customer.

16. The request processing system according to claim 13, wherein the portable terminal further includes:
an answer timing input unit configured to input an answer timing whether to answer the request from the customer immediately or later.

17. The request processing system according to claim 16, wherein
the display unit notifies the request information transmitted at a predetermined time period until the answer timing is inputted through the answer timing input unit of the portable terminal of the plurality of agents to whom the request from the customer is assigned.

18. The request processing system according to claim 17, wherein
the display unit changes an enhancement degree for notifying the request information transmitted in accordance with a number of notifications of the request information transmitted or a time period until a designated time designated in the request from the customer.

19. The request processing system according to claim 13, wherein
the answer input unit is configured as a button on the display unit.

20. The request processing system according to claim 13, wherein
the processing status includes:
a status where the agent carrying the portable terminal is decided as the agent who accepts the request from the customer;
a status where the agent carrying the portable terminal answered that the request from the customer cannot be accepted;
a status where the agent other than the agent carrying the portable terminal was decided as the agent who accepts the request from the customer before the agent carrying the portable terminal answers the request from the customer; and
a status where the agent other than the agent carrying the portable terminal is decided as the agent who accepts the request from the customer after the agent carrying the portable terminal answered the request from the customer.

21. The request processing system according to claim 13, wherein
the management device further includes:
a display unit configured to display a request status of the request from the customer, wherein
the request status includes:
a status where the request from the customer has not been assigned to the plurality of agents;
a status where none of the plurality of agents to whom the request from the customer was assigned has answered as to whether the request from the customer is accepted after the request from the customer was assigned to the plurality of agents; and
a status where the agent who accepts the request from the customer has been decided.

22. The request processing system according to claim 13, wherein
the request from the customer is a collection request.

23. The request processing system according to claim 13, wherein
the request from the customer is a vehicle allocation request.
